(19) United States
(12) Patent Application Publication
(10) Pub. No.: US 2024/0014517 A1
(43) Pub. Date: Jan. 11, 2024

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); ENVISION AESC JAPAN LTD., Kanagawa (JP)

(72) Inventors: Shuya IKEDA, Osaka (JP); Osamu NAKAYAMA, Osaka (JP); Katsushi MIYAZAKI, Osaka (JP); Mitsutoshi MORITA, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); ENVISION AESC JAPAN LTD., Kanagawa (JP)

(21) Appl. No.: 18/271,111

(22) PCT Filed: Jan. 20, 2022
(86) PCT No.: PCT/JP2022/001912

§ 371 Date: Jul. 6, 2023

(30) Foreign Application Priority Data
Jan. 22, 2021 (JP) 2021-008622

(51) Int. Cl. H01M 50/519; H01M 50/507

(52) U.S. Cl. CPC H01M 50/519; H01M 50/507

(57) ABSTRACT

A wiring module is to be attached to multiple power storage elements. The wiring module includes a busbar connected to electrode terminals of the multiple power storage elements, a circuit board connected to the busbar with solder, and a protector configured to hold the busbar and the circuit board. The protector includes a busbar arrangement surface on which the busbar is disposed and a board arrangement surface on which the circuit board is disposed. The board arrangement surface and the busbar arrangement surface are perpendicular to each other.

### TECHNICAL FIELD

The present disclosure relates to a wiring module.

### BACKGROUND ART

A high-pressure battery pack that is used in an electric automobile or a hybrid automobile normally includes secondary batteries that are stacked on each other and are electrically connected in series or in parallel to each other with a battery wiring module. A busbar assembly that is disclosed in Japanese Translation of PCT International Application Publication No. 2020-520067 (Patent Document 1 described below) has been known as an example of such a wiring module. The busbar assembly described in Patent Document 1 is mounted on secondary butteries that are stacked on each other and include electrode leads protruding in opposite directions. The busbar assembly includes busbars that are connected to the electrode leads, a sensing circuit board, and a busbar frame that holds the busbars. The sensing circuit board includes connection holes through which connection protrusions of the busbars are inserted and thus, the connection protrusions are connected to the sensing circuit board. The sensing circuit board is disposed parallel to an outer surface of the busbar frame on which the busbars are mounted.

### PRIOR ART DOCUMENT

### Patent Document

Patent Document 1: Japanese Translation of PCT International Application Publication No. 2020-520067

### SUMMARY OF THE INVENTION

### Problem to be Solved by the Invention

With downsizing of the busbar assembly having the above configuration, a space for mounting the sensing circuit board is reduced and this may make electrical connection between the sensing circuit board and the busbars difficult. For example, soldering may not be performed easily.

### Means for Solving the Problem

A wiring module according to the present disclosure is a wiring module to be attached to multiple power storage elements. The wiring module includes a busbar connected to electrode terminals of the multiple power storage elements, a circuit board connected to the busbar with solder, and a protector configured to hold the busbar and the circuit board. The protector includes a busbar arrangement surface on which the busbar is disposed and a board arrangement surface on which the circuit board is disposed. The busbar arrangement surface and the board arrangement surface are perpendicular to each other.

### Effects of the Invention

According to the present disclosure, a wiring module that has a space for performing electric connection between busbars and a circuit board even with being downsized can be provided.

### BRIEF DESCRIPTION OF THE DRAWINGS

FIG. 1 is a perspective view of a power storage module according to a first embodiment.

FIG. 2 is a magnified perspective view illustrating a front portion of the power storage module.

FIG. 3 is a magnified plan view illustrating a portion of the power storage module near a circuit board.

FIG. 4 is a cross-sectional view of the wiring module taken along line A-A in FIG. 3.

FIG. 5 is a magnified perspective view of the power storage module illustrating the busbar and the circuit board that are joined together with soldering.

FIG. 6 is a magnified perspective view illustrating an upper portion of a protector.

FIG. 7 is a perspective view of a power storage element.

FIG. 8 is a plan view of a circuit board according to a second embodiment.

### MODES FOR CARRYING OUT THE INVENTION

### Description of Embodiments According to the Present Disclosure

First, embodiments according to the present disclosure will be listed and described.
(1) A wiring module according to the present disclosure is a wiring module to be attached to multiple power storage elements. The wiring module includes a busbar connected to electrode terminals of the multiple power storage elements, a circuit board connected to the busbar with solder, and a protector configured to hold the busbar and the circuit board. The protector includes a busbar arrangement surface on which the busbar is disposed and a board arrangement surface on which the circuit board is disposed. The busbar arrangement surface and the board arrangement surface are perpendicular to each other.

According to such a configuration, the board arrangement surface and the busbar arrangement surface are perpendicular to each other. Therefore, even with the wiring module being downsized, the space necessary for soldering the busbar to the circuit board can be provided.
(2) A direction that is perpendicular to the busbar arrangement surface may be defined as a first direction and a direction that is perpendicular to the board arrangement surface may be defined as a second direction. The board arrangement surface may be on one end portion of the protector with respect to the second direction. The protector may have a dimension measured in the first direction that is smaller than a dimension of the protector measured in the second direction.

In soldering the busbar to the circuit board, the protector is disposed on the working lane such that the direction perpendicular to the board arrangement surface corresponds to the upper-bottom direction and the soldering is performed by the machine disposed above the protector. With such a configuration, the dimension of the protector measured in the first direction is smaller than the dimension of the protector measured in the second direction. Therefore, a greater number of protectors can be disposed on the working lane in the configuration in which the second direction corresponds to the upper-bottom direction than in the configuration in which the first direction corresponds to the upper-bottom direction. Accordingly, the efficiency of the soldering of the busbar and the circuit board can be improved and the production efficiency of the wiring module can be improved.
(3) The circuit board may be a flexible printed circuit board. A busbar land that is electrically connected to the busbar may be mounted on the circuit board. The circuit board may include a notched portion adjacent to the busbar land.

According to such a configuration, the tolerance that is caused between the busbar and the circuit board, which are fixed to the protector, due to the expansion and contraction of the protector can be absorbed with the above configuration. Therefore, the solder with which the busbar and the circuit board are joined together is less likely to be damaged.

### Details of Embodiments According to the Present Disclosure

Embodiments according to the present disclosure will be described. The present disclosure is not limited to the embodiments. All modifications within and equivalent to the technical scope of the claimed invention may be included in the technical scope of the present invention.

### First Embodiment

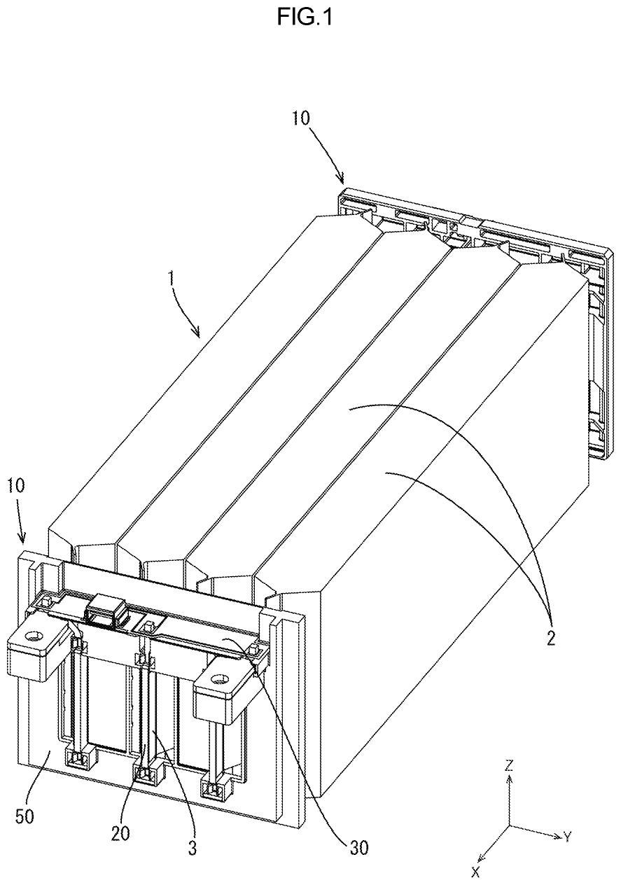

A first embodiment of the present disclosure will be described with reference to FIGS. 1 to 7. A power storage module 1 including a wiring module 10 according to this embodiment is installed in a vehicle as a power source for driving a vehicle such as an electric automobile or a hybrid automobile. In the following description, it is considered that an Z arrow, an X arrow, and a Y arrow point the upper side, the front side, and the left side, respectively. In this embodiment, a first direction corresponds to a front-rear direction and a second direction corresponds to an upper-bottom direction. Regarding components having the same configuration, some of the components may be indicated by reference signs and others may not be indicated by the reference signs.

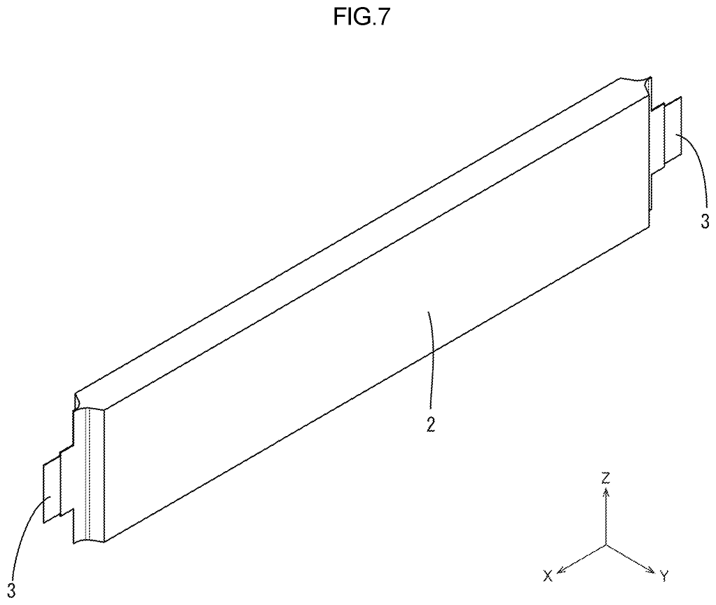

As illustrated in FIG. 1, the power storage module 1 includes multiple power storage elements 2 that are arranged in a right-left direction and the wiring modules 10 that are attached to a front side and a rear side of the power storage elements 2. As illustrated in FIG. 7, the power storage element 2 has a flat shape that is elongated in the front-rear direction and has a small thickness in the right-left direction. The power storage element 2 includes a power storage component (not illustrated) therein. Two electrode terminals 3 are on front and rear sides of the power storage element 2, respectively, and protrude from the power storage element 2 in opposite directions. The two electrode terminals 3 have a plate shape and have opposite polarities.

[Wiring Module]

As illustrated in FIG. 1, the wiring module 1 of this embodiment includes busbars 20 that are connected to the electrode terminals 3, a circuit board 30 that is connected to the busbars 20, and a protector 50 that holds the busbars 20 and the circuit board 30. The wiring modules 10 are respectively attached to a front side and rear side of the power storage elements 2. In the following, the configuration of the wiring module 10 that is attached to the front side of the power storing elements 2 will be described in detail. The configuration of the wiring module 10 that is attached to the rear side of the power storing elements 2 is similar to the configuration of the one attached to the front side and will not be described.

[Circuit Board]

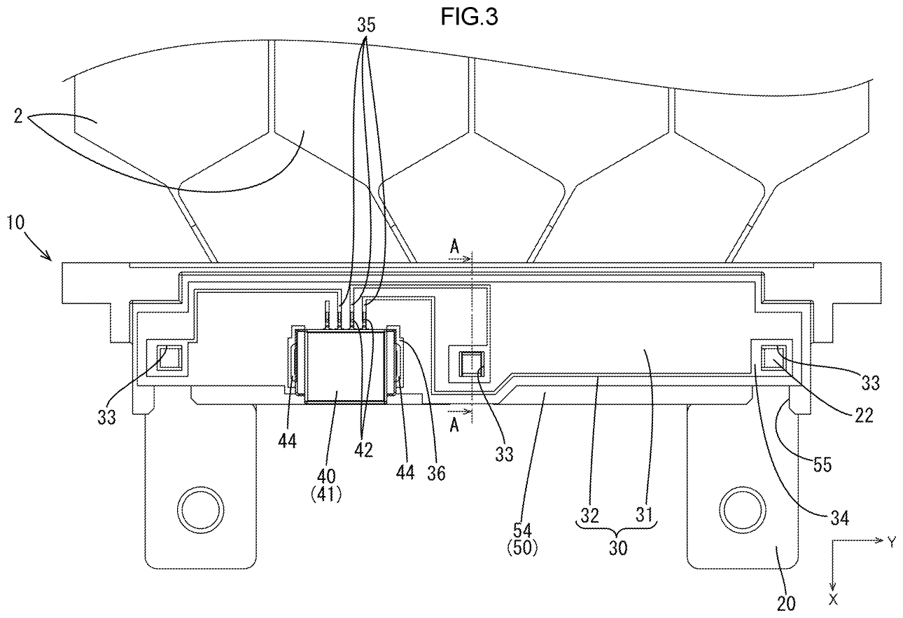

As illustrated in FIG. 3, the circuit board 30 has an elongated shape extending in the right-left direction and is mounted on the wiring module 10 such that the board thickness direction corresponds to the upper-bottom direction. The circuit board 30 includes connection holes 33 in two end portions and a middle portion with respect to the right-left direction. The connection holes 33 are through the circuit board 30 in the upper-bottom direction. The circuit board 30 is disposed on a board arrangement surface 54 of the protector 50 and bonded to the board arrangement surface 54 with adhesive or heat staking.

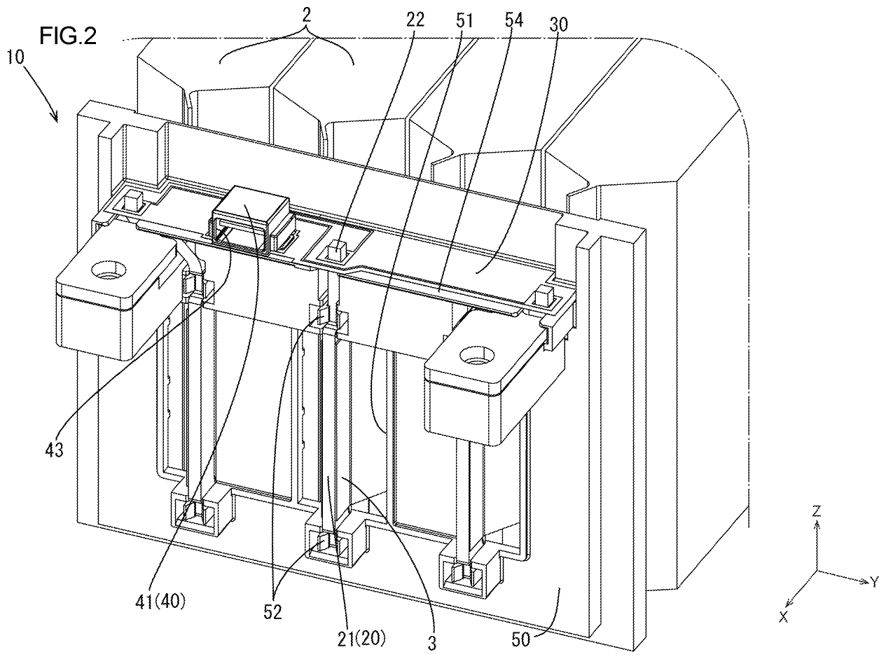

As illustrated in FIG. 3, in the wiring module 10, the circuit board 30 has a long side extending in the right-left direction that is an arrangement direction in which the power storage elements 2 are arranged and a short side extending in the front-rear direction that is perpendicular to the arrangement direction. With such a configuration, it is possible to reduce the size of the circuit board 30 and the dimension of the wiring module 10 measured in the front-rear direction while ensuring the electrical connection of the circuit board 30 and the busbars 20 in the wiring module 10. Furthermore, as illustrated in FIG. 2, since the circuit board is arranged on the upper edge section of the protector 50, operability of mounting the circuit board 30 on the protector and soldering on the circuit board 30 can be improved.

[Conductive Line]

As illustrated in FIG. 3, the circuit board 30 includes a base film 31, a conductive line 32 that is mounted on a front portion of a surface of the base film 31, and a coverlay film (not illustrated) that covers the conductive line 32 from the front side. The base film 31 and the coverlay film are made of synthetic resin such as polyimide that is flexible and has insulating properties. The conductive line 32 is made of a metal foil such as a copper foil and a copper alloy foil.

[Busbar Land]

As illustrated in FIG. 3, a busbar land 34 and a connector connection portion 35 are at two ends of the conductive line 32, respectively. The coverlay film has holes through which the busbar lands 34 and the connector connection portions 35 are exposed upward. The busbar land 34 is disposed around the connection hole 33 and is connected to one of the two ends of the connection line 32. The connector connection portions 35 are on the right side with respect to a middle of the circuit board 30 (on the left side in the drawing) and are arranged in the right-left direction. The connector connection portion 35 is at another one of the two ends of the connection line 32.

[Busbar]

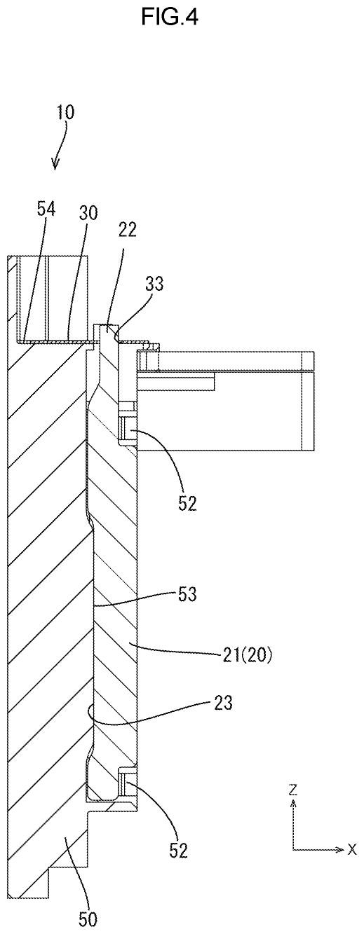

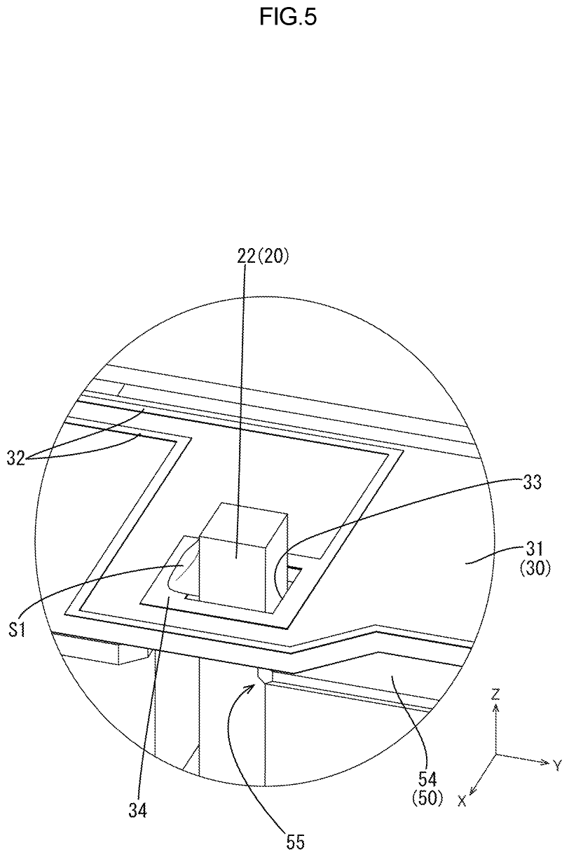

The busbar 20 has a plate shape and is made by processing an electrically conductive metal plate. As illustrated in FIG. 2, the busbar 20 is held by busbar holding portions 52 that are included in an upper portion and a lower portion of the protector 50, respectively, such that a thickness direction of the busbar 20 corresponds to the right-left direction. The busbar 20 includes a busbar body portion 21 in a middle portion thereof and the busbar body portion 21 is connected to the electrode terminal 3. As illustrated in FIG. 4, the busbar body portion 21 has a contact surface 23 on its back surface and the contact surface 23 is contacted with the protector 50 from a front side. As illustrated in FIG. 5, the busbar 20 includes a projection portion 22 in an upper portion thereof and the projection portion 22 projects upward. The projection portion 22 is fitted in a recessed portion 55 of the protector and projects upward from the board arrangement surface 54. The projection portion 22 is inserted through the connection hole 33 of the circuit board 30 and connected to the busbar land 34 with solder S1.

As illustrated in FIG. 2, when the wiring modules are attached to the front side and the rear side of the power storage elements 2, the electrode terminals 3 are fitted in electrode receiving portions 51 of the protector 50, respectively, and appropriately bent to be contacted with the busbar body portions 21, respectively. Then, the busbar body portions 21 are connected to the electrode terminals 3, respectively, with laser welding.

As illustrated in FIG. 3, a connector 40 is mounted on the circuit board 30. The connector 40 includes a housing 41 that has a rectangular parallelepiped box shape elongated in the right-left direction and terminals 42. As illustrated in FIG. 2, the housing 41 has an opening 43 that opens frontward so as to be fitted to a target connector, which is not illustrated.

As illustrated in FIG. 3, fixing members 44 made of metal are on a left surface and a right surface of the housing 41. With the fixing members 44 being connected to fixing lands 36 on the circuit board 30, the connector 40 is fixed to the circuit board 30. Ends of the terminals 42 are electrically connected to the connector connection portion 35, respectively, with soldering.

[Protector, Busbar Arrangement Surface]

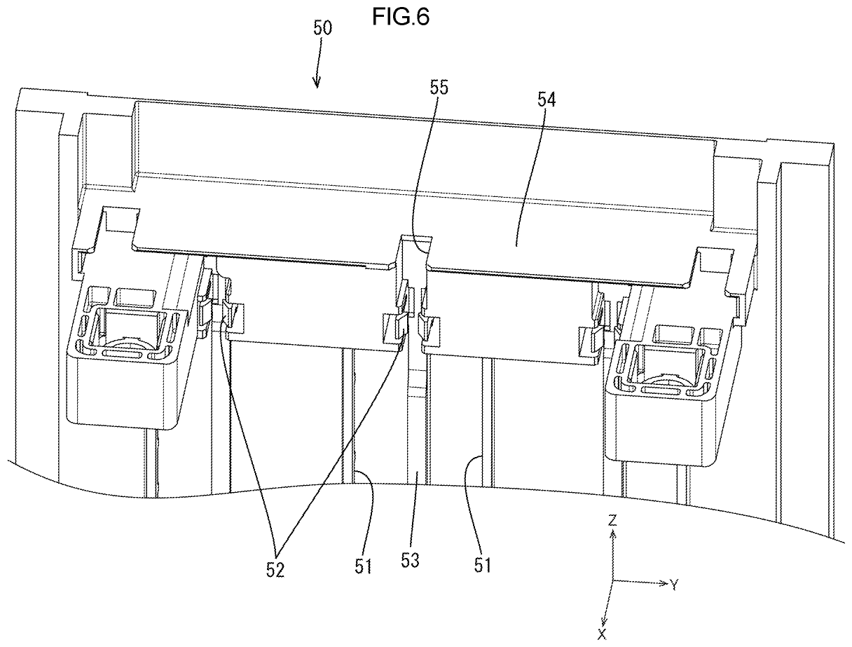

The protector 50 is made of synthetic resin having insulating properties and has a plate shape with a plate thickness direction corresponding to the front-rear direction. As illustrated in FIGS. 2 and 6, the protector 50 includes the electrode receiving portions 51 in a middle section with respect to an upper-bottom direction and the electrode receiving portions 51 are arranged in the right-left direction. The electrode receiving portions 51 are through the protector 50 in the front-rear direction and have a rectangular shape elongated in the upper-bottom direction. As illustrated in FIG. 4, the protector 50 includes the busbar holding portions 52, which hold the busbars 20, in upper and lower portions of the protector 50. The protector 50 has a busbar arrangement surface 53 between the upper and lower busbar holding portions 52. The busbar arrangement surface 53 is a reference surface for arranging the busbar 20 on the protector 50. The busbar arrangement surface 53 of the protector 50 of this embodiment is contacted with the contact surface 23 of the busbar 20 from the rear side. A first direction that is perpendicular to the busbar arrangement surface 53 is the front-rear direction in this embodiment.

[Board Arrangement Surface]

As illustrated in FIGS. 2 and 6, the protector 50 of this embodiment has the board arrangement surface 54 above the upper busbar holding portion 52. The circuit board 30 is disposed on the board arrangement surface 54. The second direction that is perpendicular to the board arrangement surface 54 is the upper-bottom direction in this embodiment. As illustrated in FIGS. and 6, the protector 50 includes the recessed portions 55, which receive the projection portions 22 of the busbars 20, in the board arrangement surface 54.

As illustrated in FIG. 4, with the board arrangement surface 54 and the busbar arrangement surface 53 being perpendicular to each other, a space for arranging the circuit board 30 and a space for arranging the busbars 20 in the protector 50 can be easily divided from each other. Specifically, in this embodiment, the busbar 20 can be arranged such that the structure of the busbar 20 other than the projection portion 22 (the busbar body portion 21) does not occupy a space on the circuit board 30. The circuit board 30 is reduced in size according to the downsizing of the wiring module 10 and the space on the circuit board 30 is reduced due to the connector 40 arranged on the circuit board 30. Even with such configurations, a space enough for soldering the projection portion 22 of the busbar 20 to the busbar land 34 of the circuit board 30 can be provided (refer to FIG. 3).

Normally, soldering of the busbar and the circuit board is performed by the machine disposed above the protector. Therefore, the protector is disposed on the working lane such that the upper-bottom direction with respect to the protector corresponds to a direction perpendicular to the circuit board (or the board arrangement surface). With respect to the production efficiency, it is preferable that the protector has the smallest possible dimensions measured in the front-rear direction and the right-left direction with considering the number of protectors that can be disposed on the working lane for soldering.

In the configuration of a prior art, the busbar arrangement surface and the board arrangement surface are parallel to each other. With such a configuration, the protector is arranged on the working lane such that the upper-bottom direction with respect to the protector corresponds to a direction perpendicular to the busbar arrangement surface (in this embodiment, the right-left direction in FIG. 4). However, the dimension of the protector measured in the direction parallel to the busbar arrangement surface is likely to be increased by the total dimension of the power storage elements (refer to FIGS. 2 and 6). Therefore, a large number of protectors could not be disposed on the working lane.

On the other hand, in this embodiment, as illustrated in FIG. 4, the protector 50 has the board arrangement surface 54 that is perpendicular to the busbar arrangement surface 53 and the dimension of the protector 50 measured in the first direction (that is perpendicular to the busbar arrangement surface 53, the right-left direction in FIG. 4) is smaller than the dimension of the protector 50 measured in the second direction (that is perpendicular to the board arrangement surface 54, the upper-bottom direction in FIG. 4). Therefore, in the configuration of this embodiment in which the second direction corresponds to the upper-bottom direction, the dimensions of the protector 50 measured in the front-rear direction and the right-left direction in the soldering process become smaller compared to those of the configuration of a prior art. Therefore, a greater number of protectors 50 can be disposed on the working lane than that in the configuration of a prior art and soldering of the busbars 20 to the circuit board 30 can be performed. This increases production efficiency of the wiring modules 10.

### Operations and Effects of First Embodiment

According to the first embodiment, operations and effects described below are obtained.

The wiring module 10 according to the first embodiment is to be mounted on multiple power storage elements 2. The wiring module 10 includes the busbars 20 that are connected to electrode terminals 3 of the power storage elements 2, the circuit board 30 that is connected to the busbars 20 with solder S1, and the protector 50 that holds the busbars 20 and the circuit board 30. The protector 50 includes the busbar arrangement surface 53 on which the busbars 20 are disposed and the board arrangement surface 54 on which the circuit board 30 is disposed. The busbar arrangement surface 53 and the board arrangement surface 54 are perpendicular to each other.

According to such a configuration, the busbar arrangement surface 53 and the board arrangement surface 54 are perpendicular to each other. Therefore, even with the wiring module 10 being downsized, the space necessary for soldering the busbars 20 to the circuit board 30 can be provided.

In the first embodiment, the direction perpendicular to the busbar arrangement surface 53 is defined as the first direction and the direction perpendicular to the board arrangement surface 54 is defined as the second direction. The protector 50 includes the board arrangement surface 54 on one end portion of the protector 50 with respect to the second direction. The dimension of the protector 50 measured in the first direction is smaller than the dimension of the protector 50 measured in the second direction.

In soldering the busbars 20 to the circuit board 30, the protector 50 is disposed on the working lane such that the second direction corresponds to the upper-bottom direction and the soldering is performed by the machine disposed above the protector 50. The protector 50 may be fixedly disposed on the working lane with another member such as a fixing base. With the above configuration, the dimension of the protector 50 measured in the first direction is smaller than the dimension of the protector 50 measured in the second direction. Therefore, a greater number of protectors 50 can be disposed on the working lane in the configuration in which the second direction corresponds to the upper-bottom direction than in the configuration in which the first direction corresponds to the upper-bottom direction. Accordingly, the efficiency of the soldering of the busbars 20 and the circuit board 30 can be improved and the production efficiency of the wiring module 10 can be improved.

### Second Embodiment

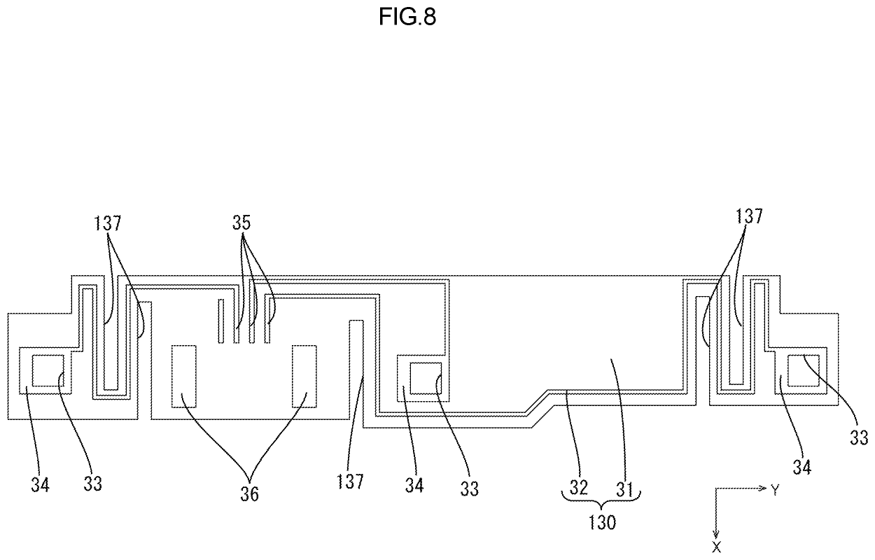

A second embodiment of the present disclosure will be described with reference to FIG. 8. The configuration of the second embodiment is same as those of the first embodiment except for notched portions 137 in a circuit board 130. In the following description, components having the same configurations as those of the first embodiment are indicated by the reference signs used in the first embodiment and operations and effects same as those of the first embodiment will not be described.

The circuit board 130 of this embodiment is a flexible printed circuit board having flexibility. As illustrated in FIG. 8, the circuit board 130 includes notched portions 137 adjacent to the busbar lands 34. The notched portions 137 are recessed in the front-rear direction. With the flexible circuit board 130 including the notched portions 137, the circuit board 130 can be expandable with respect to the front-rear direction, the upper-bottom direction, and the right-left direction. With such a configuration, if the protector 50 expands or contracts, the circuit board 130 also expands or contracts accordingly to absorb tolerance between the protector 50 and the circuit board 130 and tolerance between the busbars 20 and the circuit board 130 that are fixed to the protector 50.

With the notched portions 137 being adjacent to the busbar lands 34, the tolerance between the busbars 20 and the circuit board 130 that is caused adjacent to the busbar lands 34 is likely to be absorbed. Therefore, if the protector 50 expands or contracts, a force is less likely to be applied on the solder S1 with which the projection portion 22 of the busbar 20 and the busbar land 34 are joined together and solder cracks are less likely to occur.

### Operations and Effects of Second Embodiment

According to the second embodiment, operations and effects described below are obtained.

In the second embodiment, the circuit board 130 is a flexible printed circuit board. The circuit board 130 includes the busbar lands 34 that are electrically connected to the busbars 20 and includes the notched portions 137 adjacent to the busbar lands 34.

According to the above configuration, it is possible to absorb a tolerance that is generated between the busbars 20 and the circuit board 130 on the protector 50 due to the expansion and contraction of the protector 50. Therefore, the solder S1 with which the busbars 20 and the circuit board 130 are joined together is less likely to be damaged.

### Other Embodiments

(1) In the above embodiments, the circuit board 30, 130 includes the connection holes 33 and the protector 50 includes the recessed portions 55. However, the connection holes and the recessed portions may not be included.
(2) In the above embodiments, the power storage element 2 is a laminated type battery. However, the wiring module of the present disclosure can be applied to various types of power storage elements such as cylindrical type batteries and square batteries.
(3) In the above embodiments, the connector 40 is connected to the circuit board 30, 130. However, the connector may not be connected to the circuit board.

### EXPLANATION OF SYMBOLS

1: Power storage module
2: Power storage element
3: Electrode terminal
10: Wiring module
20: Busbar
21: Busbar body portion
22: Projection portion
23: Contact surface
130: Circuit board
31: Base film
32: Conductive line
33: Connection hole
34: Busbar land
35: Connector connection portion
36: Fixing land
40: Connector
41: Housing
42: Terminal
43 Opening
44: Fixing member
50: Protector
51: Electrode receiving portion
52: Busbar holding portion
53: Busbar arrangement surface
54: Board arrangement surface
55: Recessed portion
137: Notched portion
S1: Solder

1. A wiring module to be attached to multiple power storage elements, the wiring module comprising:
a busbar connected to electrode terminals of the multiple power storage elements;
a circuit board connected to the busbar with solder; and
a protector configured to hold the busbar and the circuit board, the protector including a busbar arrangement surface on which the busbar is disposed and a board arrangement surface on which the circuit board is disposed, wherein
the busbar arrangement surface and the board arrangement surface are perpendicular to each other.

2. The wiring module according to claim 1, wherein
a direction that is perpendicular to the busbar arrangement surface is defined as a first direction,
a direction that is perpendicular to the board arrangement surface is defined as a second direction,
the board arrangement surface is on one end portion of the protector with respect to the second direction, and
the protector has a dimension measured in the first direction that is smaller than a dimension of the protector measured in the second direction.

3. The wiring module according to claim 1, wherein
the circuit board is a flexible printed circuit board,
a busbar land that is electrically connected to the busbar is mounted on the circuit board, and
the circuit board includes a notched portion adjacent to the busbar land.

4. The wiring module according to claim 2, wherein
the circuit board is a flexible printed circuit board,
a busbar land that is electrically connected to the busbar is mounted on the circuit board, and
the circuit board includes a notched portion adjacent to the busbar land.
